(19) United States
(12) Patent Application Publication
(10) Pub. No.: US 2026/0044560 A1
(43) Pub. Date: Feb. 12, 2026

(54) TECHNIQUES FOR IDENTIFYING GROUND FEATURES AND ENABLING VIRTUAL INTERACTIONS THEREWITH

(71) Applicant: Smarter Reality, LLC, Round Rock, TX (US)

(72) Inventor: Walter Franklin Coppersmith, III, Round Rock, TX (US)

(73) Assignee: Smarter Reality, LLC, Round Rock, TX (US)

(21) Appl. No.: 19/362,630

(22) Filed: Oct. 20, 2025

Related U.S. Application Data
(63) Continuation-in-part of application No. 18/815,760, filed on Aug. 26, 2024.
(60) Provisional application No. 63/585,400, filed on Sep. 26, 2023.

(51) Int. Cl. G06F 16/532; G06F 16/538; G06T 17/05

(52) U.S. Cl. CPC G06F 16/532; G06F 16/538; G06T 17/05

(57) ABSTRACT

In one embodiment, a method may receive a search query as input, wherein the search query comprises certain criteria. Based on the search query, the method may receive data related to a certain area, wherein the data includes images of the certain area, and generate, based on the data and using an artificial intelligence engine, contingency landing sites in the certain area, wherein each of the contingency landing sites include at least a suitability score determined based on the certain criteria, and wherein the artificial intelligence engine is trained via weights to identify each pixel associated with each of the contingency landing sites and to use visual elements at each pixel to represent each of the contingency landing sites in a visual model. The method may cause, on a user interface, presentation of the visual model, and may receive a selection of a contingency landing site.

### CROSS-REFERENCE TO RELATED APPLICATIONS

The present application is a continuation-in-part of and claims priority to and the benefit of U.S. application Ser. No. 18/815,760, titled “TECHNIQUES FOR IDENTIFYING GROUND FEATURES AND ENABLING VIRTUAL INTERACTIONS THEREWITH,” filed Aug. 26, 2024, which claims priority to and the benefit of U.S. Provisional Application No. 63/585,400, titled “TECHNIQUES FOR IDENTIFYING GROUND FEATURES AND ENABLING VIRTUAL INTERACTIONS THEREWITH,” filed Sep. 26, 2023, the contents of which are incorporated by reference herein in their entirety for all purposes.

### FIELD OF INVENTION

The embodiments described herein set forth techniques for identifying ground features and enabling virtual interactions therewith. In particular, the techniques involve providing search results for ground features based on specified requirements, enabling users to access overview information associated with the ground features, and enabling users to interact with the ground features through aerial-based and/or ground-based virtual environments.

### BACKGROUND

Identifying remote locations that align with a specific set of requirements can be challenging due to various reasons. For example, comprehensive and accurate information about remote locations is often unavailable, which can make it difficult to assess whether such locations would actually satisfy the set of requirements. Additionally, the unique environmental, cultural, or geopolitical conditions of remote locations can introduce unexpected variables that may not align with the set of requirements. These complexities can necessitate extensive research, collaboration with local experts, and potentially even exploratory visits to ensure that the remote locations satisfy the set of requirements. Such complexities can be untenable for a variety of reasons, such as excessive visitation costs, the general inability to reach (and/or to receive permission to access) the remote locations, and so on. Additionally, physical visits to remote locations may undesirably reveal information about the visitors, their intent, and so on.

Additionally, even when remote locations are successfully identified, performing on-site visits can present myriad challenges that significantly impact the efficiency and effectiveness of the visit. For example, a primary obstacle in visiting a given remote location is the general remoteness, and inaccessibility, of the location itself. In particular, remote areas are often characterized by difficult terrain, limited transportation options, and lack of basic infrastructure. This can make it challenging and time-consuming to reach the location, which can delay the initiation of the visit and reduce the overall amount of time that is available for conducting salient assessments, inspections, and so on.

Additionally, logistical challenges can come into play, including securing appropriate accommodations, ensuring availability of necessary supplies and equipment, and arranging for reliable access to communications. For example, the remoteness of a given location may result in limited or unreliable access to essential services such as electricity, internet connectivity, and even clean water, which can further complicate the visit. Without such basic amenities, the team conducting the visit may struggle to efficiently carry out their tasks and to effectively communicate with their base or headquarters.

Weather and environmental conditions can also create other hurdles. For example, remote locations often experience extreme or unpredictable weather patterns, such as storms, snow, or excessive heat, thereby making travel and operations precarious during certain times. These conditions can pose risks to the safety of the team and impact the ability to conduct planned activities. Furthermore, the lack of local expertise and knowledge about the terrain and environment in remote areas can make it challenging to plan for contingencies and to manage unexpected circumstances.

Accordingly, what is needed are improved techniques for identifying and assessing remote locations based on a set of requirements.

### SUMMARY

The embodiments described herein set forth techniques for identifying ground features and enabling virtual interactions therewith. In particular, the techniques involve providing search results for ground features based on specified requirements, enabling users to access overview information associated with the ground features, and enabling users to interact with the ground features through aerial-based and/or ground-based virtual environments.

One embodiment sets forth a method for identifying ground features and enabling virtual interactions therewith. According to some embodiments, the method can be implemented by a computing device, and includes the steps of (1) receiving a search request to identify ground features that satisfy a plurality of requirements, (2) analyzing geospatial information to identify one or more ground features that satisfy the plurality of requirements, wherein each ground feature corresponds to a respective portion of the geospatial information, (3) generating, for each ground feature of the one or more ground features, respective supplemental information that complements the respective portion of the geospatial information, and (4) displaying a user interface (UI) that includes, for the one or more ground features, a respective UI element that includes at least a portion of the respective supplemental information that corresponds to the ground feature.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of different entities that can be configured to perform the various techniques described herein, according to some embodiments.

FIGS. 2A-2C illustrate conceptual diagrams of example search engine user interfaces that can be displayed to a user of a computing device, according to some embodiments.

FIGS. 3A-3D illustrate conceptual diagrams of aerial-based virtual environments, according to some embodiments.

FIG. 4 illustrates a conceptual diagram of a ground-based virtual environment, according to some embodiments.

FIG. 5 illustrates a method for identifying ground features and enabling virtual interactions therewith, according to some embodiments.

FIG. 6 illustrates a detailed view of a computing device that can be used to implement the various techniques described herein, according to some embodiments.

FIG. 7 illustrates a method for searching for and selecting contingency landing sites, according to some embodiments.

FIG. 8 illustrates a method for generating a three-dimensional (3D) model of a selected contingency landing site, according to some embodiments.

FIG. 9 illustrates a conceptual diagram of a search engine user interface including suitability and confidence scores for each contingency landing site, according to some embodiments.

FIG. 10 illustrates a conceptual diagram of a 3D model including annotations and measurements overlaid on a contingency landing site, according to some embodiments.

FIG. 11 illustrates a conceptual diagram including multiple user interface examples of an AI-generated 3D visual model of a selected contingency landing site that enables a user to walkthrough and confirm its suitability for desired criteria, according to some embodiments.

### NOTATION AND NOMENCLATURE

Various terms are used to refer to particular system components. Different entities may refer to a component by different names - this document does not intend to distinguish between components that differ in name but not function. In the following discussion and in the claims, the terms “including” and “comprising” are used in an open-ended fashion, and thus should be interpreted to mean “including, but not limited to.... ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of Decisions, means that different combinations of one or more of the listed Decisions may be used, and only one item in the list may be needed. For example, “at least one of: A, B, and C” includes any of the following combinations: A, B, C, A and B, A and C, B and C, and A and B and C. In another example, the phrase “one or more” when used with a list of Decisions means there may be one item or any suitable number of Decisions exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

The embodiments described herein set forth techniques for identifying ground features and enabling virtual interactions therewith. In particular, the techniques involve providing search results for ground features based on specified requirements, enabling users to access overview information associated with the ground features, and enabling users to interact with the ground features through aerial-based and/or ground-based virtual environments.

According to some embodiments, the techniques can be implemented as an artificial intelligence (AI)-enabled software-as a service that enables users to identify, evaluate, and conduct virtual site visits of ground features—such as roads, runways, waterways, water bodies, etc., that can potentially be utilized as contingency airfields—in remote or nearby areas. This approach can streamline the process of identifying potential contingency airfields that are suitable for a given need, application, and so on. Potential contingency airfields can constitute, for example, semi-permanent contingency locations (SCLs), temporary contingency locations (TCLs), initial contingency locations (ICLs), and so on. An SCL, for example, can constitute a contingency location that provides support for a prolonged contingency operation and that is characterized by enhanced infrastructure and support services consistent with sustained operations. A TCL, for example, can constitute a continency location that provides near-term support for a continency operation and that is characterized by expedient infrastructure and support services that have been expanded beyond organic service capabilities. An ICL, for example, constitutes a contingency location that is occupied by a force in immediate response to a contingency operation and that is characterized by austere infrastructure and limited services with little or no external support except through organic capabilities.

Non-limiting examples of benefits that can be afforded by implementing the techniques described herein include (1) reduced amounts of time and effort otherwise currently required for the manual identification, inspection, etc., of potential contingency airfields, (2) improved mission planning via near-immediate access to mission-relevant information, (3) improved search result relevance through customizable search parameters and advanced search engine implementations, (4) increased decision-making efficiency through the utilization of AI-generated suitability scores, combined with any number of sub-scores, that function as objective and easy-to-understand ratings for different characteristics of potential contingency airfields, and (5) enabling aerial-based and ground-based virtual site visits that provide a clear and intuitive way to assess potential contingency airfields and to inform decision making processes.

According to some embodiments, the techniques enable a given user to select a particular region (e.g., a pinned location, a geofence, etc.), and to establish priority decision-making criteria (such as requisite surface dimension ranges, surface materials, surface slope/grade ranges, a surface condition range, an elevation range, obstacle clearance ranges, available storage options, available security options, available infrastructure options, available transportation options, distance ranges to strategic locations, and the like). In turn, potential contingency fields are identified, respective one or more suitability scores are assigned to the potential contingency airfields, and then the potential contingency airfields are sorted based on their respective suitability scores. Users can then evaluate each potential contingency airfield by reviewing their locations, suitability scores, and airfield layouts (e.g., using aerial-based and/or ground-based virtual environments).

Additionally, and as a brief aside, it is noted that the while this disclosure is primarily directed to analyzing ground features that constitute potential contingency airfields, the embodiments are not so limited. For example, the techniques can be employed to identify waterways, water bodies, etc., that can function as acceptable areas in which ships, submarines, seaplanes, etc., can effectively gather and function (e.g., based on average wave heights, depths, surface area, surround terrain, etc.). In another example, the techniques can be used to identify clearings (of any kind) that can function as acceptable areas for paratroopers, supplies, helicopters, etc., to be effectively deployed. In yet another example, the techniques can be used to identify shrouded areas (such as forests, mountains, caves, etc.) that can function as acceptable locations from which to deploy covert operations. It is noted that the foregoing examples are not meant to be limiting, and that any number, type, form, etc., of ground feature can be analyzed, at any level of granularity, to effectively determine whether a given ground feature is appropriate to facilitate one or more tasks, without departing from the scope of this disclosure.

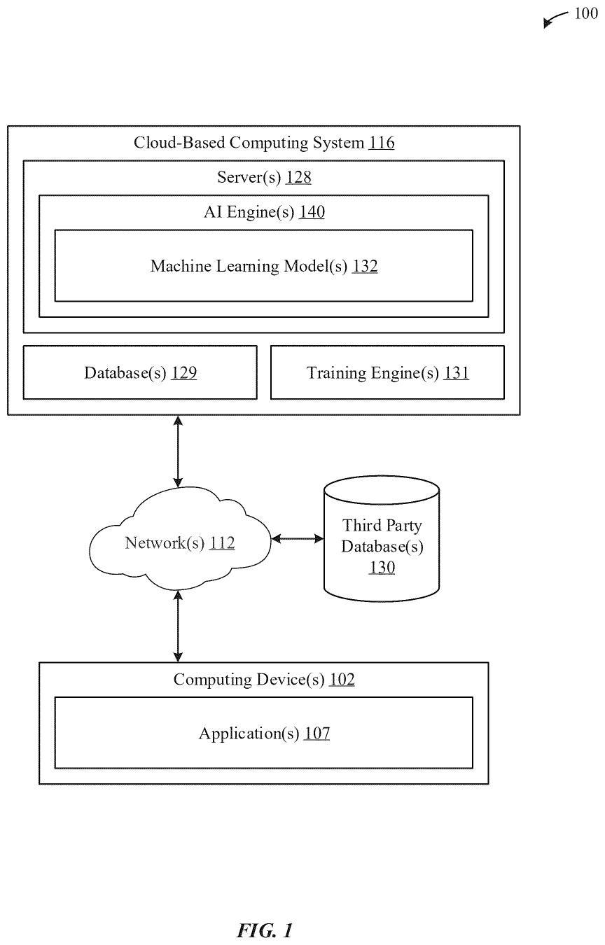

A more detailed description of the foregoing techniques will now be provided below in conjunction with FIGS. 1, 2, 3A-3D, and 4-6.

To explore the foregoing in more detail, FIG. 1 will now be described. FIG. 1 illustrates a high-level component diagram of an illustrative system architecture 100, according to certain embodiments of this disclosure. In some embodiments, the system architecture 100 may include computing devices 102, a cloud-based computing system 116, and/or one or more third-party databases 130 that are communicatively coupled via one or more networks 112. As used herein, a cloud-based computing system refers, without limitation, to any remote or distal computing system accessed over a network communications link. Each of the computing devices 102 may include one or more processing devices, memory devices, network interface devices, and so on.

The network interface devices of the computing devices 102 may enable communication via a wireless protocol for transmitting data over short distances, such as Bluetooth, ZigBee, near field communication (NFC), and so on. Additionally, the network interface devices may enable communicating data over long distances, and in one example, the computing devices 102 may communicate with one of the networks 112. The networks 112 may represent, for example, a public network (e.g., the Internet, access via wired (Ethernet) or wireless (Wi-Fi/cellular) connections), a private network (e.g., a local area network (LAN), wide area network (WAN), virtual private network (VPN)), or some combination thereof.

The computing device 102 may be any suitable computing device, such as a laptop, tablet, smartphone, virtual reality device, augmented reality device, desktop computer, and so on. The computing device 102 may include a display that is capable of presenting user interfaces of applications 107. As one example, the computing device 102 may be operated by individuals seeking to identify ground features—such as potential contingency airfields—based on a set of requirements, and to subsequently evaluate, analyze, interact with, etc., the potential contingency airfields that are identified. A given application 107 may be implemented through computer instructions stored on a memory of the computing device 102 and executed by a processing device of the computing device 102. Alternatively, the application 107 may be implemented as a web browser that is configured to obtain interpretable content to be displayed through the web browser. It is noted that the foregoing examples are not meant to be limiting, and that the application 107 can be implemented using any platform/approach without departing from the scope of this disclosure.

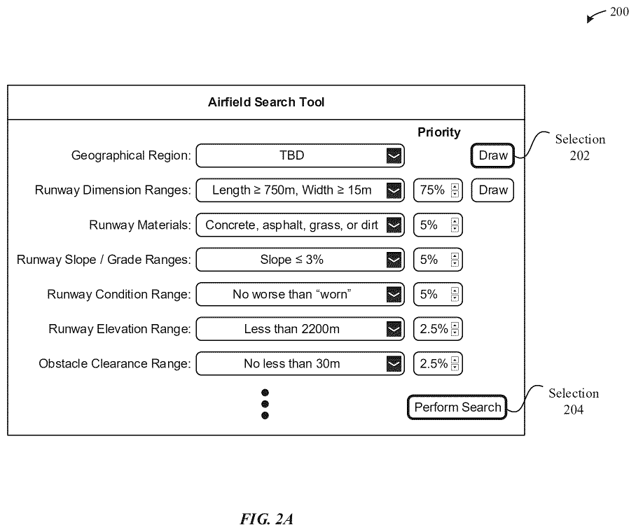

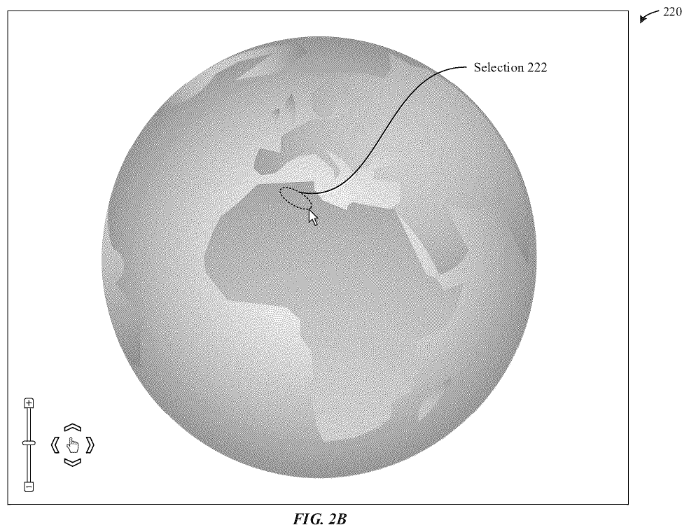

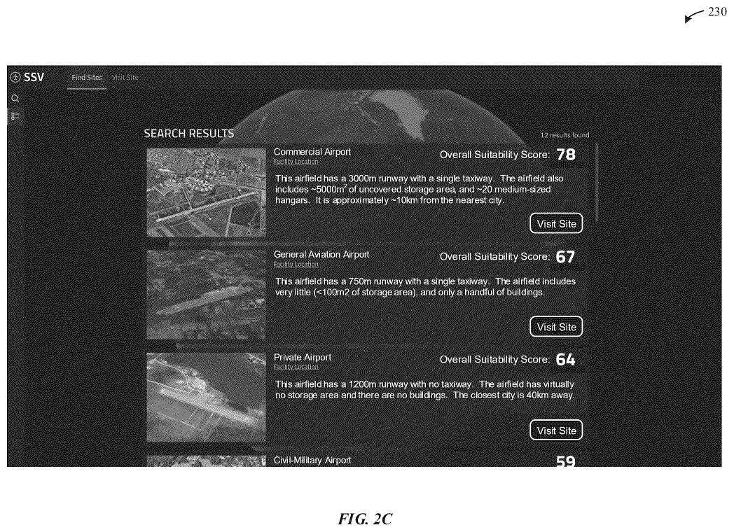

According to some embodiments, the application 107 can take the form of a video game that is configured to provide an interactive environment that enables users to input search requirements and explore search results (e.g., potential contingency airfields) that are identified and returned by the cloud-based computing system 116. The application 107 can also enable the users to access aerial-based and ground-based virtual environments that are modeled for (i.e., representative of) the potential contingency airfields. A more detailed discussion of the application 107 is provided below in conjunction with FIGS. 2A-2C, 3A-3D, and 4-5.

According to some embodiments, the cloud-based computing system 116 may include one or more servers 128 that form a distributed, grid, and/or peer-to-peer (P2P) computing architecture. Each of the servers 128 may include one or more processing devices, memory devices, data storage devices, network interface devices, and so on. The servers 128 may execute one or more AI engines 140 that utilize one or more machine learning models 132 to implement at least one of the embodiments disclosed herein. The servers 128 may be in communication with one another via any suitable communication protocol. In some embodiments, the cloud-based computing system 116 may include one or more databases 129. The cloud-based computing system 116 may also be connected to one or more third-party databases 130.

According to some embodiments, the training engines 131 can be capable of generating and maintaining the one or more machine learning models 132. Although depicted separately from the AI engines 140, the training engines 131 may, in some embodiments, be included in the AI engines 140 executing on the server 128. In some embodiments, the AI engines 140 may use the training engines 131 to generate the machine learning models 132 trained to perform inferencing operations, predicting operations, determining operations, controlling operations, and the like. The machine learning models 132 may be generated by the training engines 131 and may be implemented in computer instructions executable by one or more processing devices of the training engines 131 or the servers 128. To generate the machine learning models 132, the training engines 131 may train the machine learning models 132.

The training engine 131 can be implemented on a rackmount server, a router, a personal computer, a portable digital assistant, a smartphone, a laptop computer, a tablet computer, a netbook, a desktop computer, an Internet of Things (IoT) device, any other desired computing device, or any combination of the above. The training engine 131 may be cloud-based, be a real-time software platform, include privacy software or protocols, or include security software or protocols.

The machine learning models 132 may refer to model artifacts created by the training engines 131 using training data that includes training inputs and corresponding target outputs. The training engines 131 may find patterns in the training data, where such patterns map the training input to the target output and generate the machine learning models 132 that capture these patterns. Although depicted separately from the server 128, in some embodiments, the training engines 131 may reside on server 128. Further, in some embodiments, the artificial intelligence engines 140, the databases 129, and/or the trainings engine 131 may reside on the computing devices 102.

According to some embodiments, a given machine learning model 132 can represent, for example, a single level of linear or non-linear operations (e.g., a support vector machine (SVM)), or the machine learning model 132 can represent a deep network, e.g., a machine learning model comprising multiple levels of non-linear operations. Non-limiting examples of deep networks are neural networks, including generative adversarial networks, convolutional neural networks, recurrent neural networks with one or more hidden layers, and fully connected neural networks (e.g., each artificial neuron may transmit its output signal to the input of the remaining neurons, as well as to itself). For example, the machine learning model 132 can include numerous layers or hidden layers that perform calculations (e.g., dot products) using various neurons. In some embodiments, one or more of the machine learning models 132 may be trained to use causal inference and counterfactuals.

For example, a machine learning model 132 trained to use causal inference may accept one or more inputs, such as (i) assumptions, (ii) queries, and (iii) data. The machine learning model 132 may be trained to output one or more outputs, such as (i) a decision as to whether a query may be answered, (ii) an objective function (also referred to as an estimand) that provides an answer to the query for any received data, and (iii) an estimated answer to the query and an estimated uncertainty of the answer, where the estimated answer is based on the data and the objective function, and the estimated uncertainty reflects the quality of data (i.e., a measure which takes into account the degree or salience of incorrect data or missing data). The assumptions may also be referred to as constraints and may be simplified into statements used in the machine learning model 132.

According to some embodiments, the cloud-based computing system 116 can implement search, mapping, simulation, gaming, etc., technologies to provide a toolkit for identifying, evaluating, and selecting potential contingency airfields. In particular, the techniques can include acquiring a collection of high-resolution images of a given target area, object, etc. from various angles, positions, elevations, etc., that constitute comprehensive coverage of the target. The images can be obtained, for example, from the National Geospatial Intelligence Agency, DigitalGlobe, Planet Labs, OpenStreet Map, the Federal Aviation Administration, and so on. The images can be stored in the databases 129, the third-party databases 130, and so on. Next, features, points of interest, etc., are identified and matched across the aforementioned images, thereby establishing correspondences that enable the creation of a point cloud. In turn, a 3D model, including surfaces and textures, can be generated by interpolating the point cloud data. The 3D model can be further refined through additional processing steps for accuracy and realism. The 3D model can then be imported into simulation software—such as the applications 107—to enable the aerial-based and ground-based virtual environments to be accessed and explored. The foregoing techniques can be implemented by the cloud-based computing system 116 using any number of servers 128, AI engines 140, machine learning models 132, training engines 131, and so on.

As a brief aside, it is noted that any of the techniques implemented by the cloud-based computing system 116 can be implemented by the computing device 102 (i.e., independent from, in addition to, etc., the cloud-based computing system 116), without departing from the scope of this disclosure. Additionally, it should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

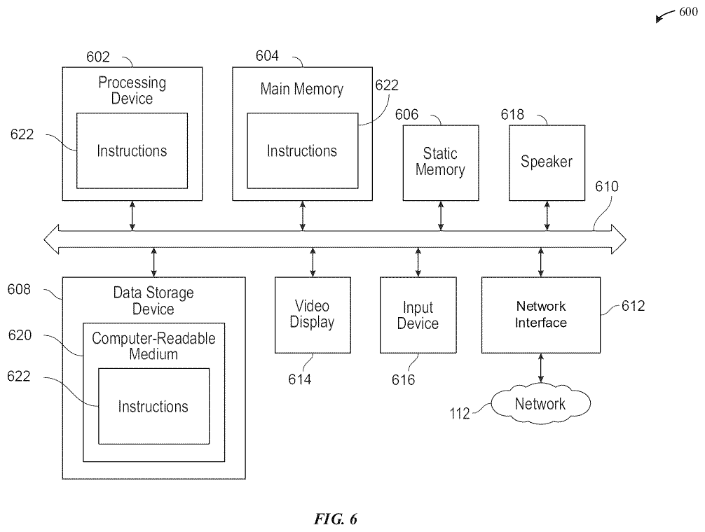

A more detailed explanation of these hardware components is provided below in conjunction with FIG. 6. It should additionally be understood that the computing devices can include additional entities that enable the implementation of the various techniques described herein without departing from the scope of this disclosure. It should additionally be understood that the entities described herein can be combined or split into additional entities without departing from the scope of this disclosure. It should further be understood that the various entities described herein can be implemented using software-based or hardware-based approaches without departing from the scope of this disclosure.

Accordingly, FIG. 1 provides an overview of the manner in which the system 100 can implement the various techniques described herein, according to some embodiments. A more detailed breakdown of the manner in which these techniques can be implemented will now be provided below in conjunction with FIGS. 2A-2C, 3A-3D, and 4-5.

FIGS. 2A-2C illustrate conceptual diagrams of example search engine user interfaces that can be displayed to a user of a computing device 102 during a hypothetical engagement with the application 107, according to some embodiments. In particular, in the examples illustrated in FIGS. 2A-2C, the application 107 permits the user to input search requirements for potential contingency airfields, and to view search results for the potential contingency airfields. Again, however, it is noted that the embodiments are not limited to airfield-based utilizations, and that the embodiments can be applied to any form, type, etc., of ground feature, at any level of granularity, without departing from the scope of this disclosure.

As shown in the conceptual diagram 200 of FIG. 2A, the application 107 displays an airfield search tool that includes UI elements (also referred to herein as “affordances”) that enable the user to input values for different search requirements. In particular, and as shown in FIG. 2A, the airfield search tool can enable the user to specify geographical regions, surface dimension ranges, surface materials, surface slope/grade ranges, a surface condition range, an elevation range, and obstacle clearance ranges. Additional specifications can be provided by the user, such as available storage options, available security options, available infrastructure options, available transportation options, and distance ranges to strategic locations. It is noted that the foregoing examples are not meant to be limiting, and that the application 107 can support any number, type, form, etc., of search parameter, at any level of granularity, without departing from the scope of this disclosure.

According to some embodiments, and as shown in FIG. 2A, dropdown options can be provided to enable the user to select from suggested values, previously-input values, and so on. According to some embodiments, the suggested values can be identified using AI models that predict values for (yet-to-be provided) input values based on, for example, the user's previous interactions with the application 107, one or more values that have been input by the user (e.g., within the scope of a new search task), other users'interactions with the airfield search tool, and so on. For example, if the user specifies that the runway must be at least 3000 m long and at least 60 m wide, then one or more AI models may prepopulate the “Runway Materials” search field with “asphalt or concrete” (given, in all likelihood, a runway of that size would not be formed out of grass or dirt).

In another example, one or more of the search requirements can be assigned values based on desired vehicle compatibilities (e.g., aircraft types/names, vehicle types/names, etc.) specified by the user. For example, if the user specifies particular military planes that must be capable of landing at potential contingency airfields, then the AI models can identify the minimum required runway lengths for the military planes, and set the minimum runway length requirement to the maximum required runway length among the military planes. The values can also be assigned, adjusted, etc., based on desired applications, utilizations, etc., specified by the user for the potential contingency airfields. For example, the aforementioned minimum required runway length can be increased when the user indicates that the military planes will be tasked with carrying fuel bladders (where the higher weight implies increased landing/takeoff distance requirements). Alternatively, the aforementioned minimum required runway length can be decreased when the user indicates that the military planes will be tasked with carrying personnel (where the lighter weight implies decreased landing/takeoff distance requirements).

Additionally, priority options can be provided to enable the user to input respective priorities (i.e., weights) for particular search requirements to be considered when searching for potential contingency airfields. Suggested values for such priorities can also be provided by AI models based on the user's previous interactions with the application 107, one or more values that have been input by the user (e.g., within the scope of a new search task), other users'interactions with the airfield search tool, and so on. Priorities can also be provided, altered by, etc., the AI models to account for user specifications of airplanes, vehicles, etc., that the potential contingency airfields must be capable of accommodating, as well as desired applications, utilizations, etc., of the potential contingency airfields.

According to some embodiments, the application 107 can employ different mechanisms to streamline the manner in which the user is able to identify, provide, etc., search requirements that are relevant. For example, as the user navigates/inputs information into the airfield search tool, the application 107 can be configured to reorder the search requirements, display new/hidden search requirements, and so on. For example, if the user specifies that the airfield should be at least 1000 km from the nearest city, then the application 107 can deprioritize/hide the search parameters for the available transportation options (given, presumably, there are no permanent roads that lead to such an airfield). In another example, if the user narrows the search to a geographical region where the landscape is relatively flat (e.g., a large dry lake bed), then the application 107 can populate the runway elevation range search field with the elevation of the landscape, and move that search field to a lower position within the list. It is noted that the foregoing examples are not meant to be limiting, and that any number, type, form, etc., of mechanisms can be applied to assist, guide, etc., the user in inputting values into the airfield search tool, without departing from the scope of this disclosure.

Additionally, drawing UIs can enable the user to conveniently provide parameters for the geographical region to be searched, the surface dimension ranges to be searched, and so on. For example, for the geographical region, one of the aforementioned drawing UIs can display a 3D or 2D map onto which the user can draw a perimeter around one or more areas to which the search should be limited. An example of this feature is illustrated in the conceptual diagram 220 of FIG. 2B, which is displayed after the application 107 receives a selection 202 (in FIG. 2A) to draw the geographical region to be searched. In turn, and as shown in the conceptual diagram 220 of FIG. 2B, the user performs a selection 222 of the geographical region to be searched. When the selection 222 is provided, the airfield search tool can be redisplayed with information that corresponds to the selection 222. In another example, for the surface dimension ranges, one of the aforementioned drawing UIs can display a virtual surface onto which the user can conveniently draw (e.g., using a mouse click and drag) the shape/size of a runway, building, storage area, etc., to be identified. It is noted that the foregoing examples are not meant to be limiting. For example, the user can be permitted to draw any number of runway configurations, taxiway configurations, building configurations, etc., that are desirable, which can then be mapped to real-world air fields that possess at least some the characteristics (e.g., within overall/respective acceptable tolerances provided by the user).

When the relevant search requirements have been established—and the application 107 receives a selection 204 to perform a search based on the search requirements—the application 107 can provide the search requirements to the cloud-based computing system 116. In response, the cloud-based computing system 116 can, using the various techniques described herein, generate search results based on the search requirements. For example, the cloud-based computing system 116 can analyze geospatial information to identify one or more potential contingency airfields that satisfy the search requirements, where each potential contingency airfield corresponds to a respective portion of the geospatial information. It is noted that additional/alternative information can be considered when performing the search/analysis, such as airport/facility directory (AFD) documents, chart supplements, and the like. In any case, the cloud-based computing system 116 can generate, for each potential contingency airfield of the one or more potential contingency airfields, respective supplemental information that complements the respective portion of the geospatial information. According to some embodiments, the supplemental information can be generated based on the geospatial information, the aforementioned additional/alternative information, other available information, and so on.

According to some embodiments, the supplemental information for a given potential contingency airfield can include overview information that includes an aerial image of the potential contingency airfield, a name of the potential contingency airfield, location information associated with the potential contingency airfield, description information that at least pertains to how the potential contingency airfield satisfies the search requirements, a suitability score that is based at least in part on an overall strength by which the potential contingency airfield satisfies the search requirements, and so on. The overall strength can be based on, for example, any number of sub-scores that represent respective strengths by which different characteristics of the potential contingency airfield satisfy the search requirements. It is noted that the foregoing examples are not meant to be limiting, and that the application 107 can generate any amount, type, form, etc., of overview (or additional) information, at any level of granularity, without departing from the scope of this disclosure.

According to some embodiments, the aerial image can be clipped from an aerial image of the potential contingency airfield, generated (e.g., using AI-based image generation techniques) based on characteristics of the potential contingency airfield, and so on. According to some embodiments, the name of the potential contingency airfield can be gathered from available information (e.g., the geospatial information, the aforementioned documentation, the Internet, etc.), generated (e.g., using AI-based text generation techniques) based on characteristics of the potential contingency airfield (and/or surrounding areas, structures, etc.), and so on. According to some embodiments, the location information can be gathered from the aforementioned available information, generated (e.g., using AI-based techniques that compare geospatial images that do not possess longitude/latitude coordinates against neighboring geospatial images that do possess such coordinates, to effectively approximate the relevant coordinates), and so on. According to some embodiments, the description information can be gathered from the aforementioned available information, generated (e.g., using AI-based text generation techniques) based on characteristics of the potential contingency airfield (and/or surrounding areas, structures, etc.), and so on.

Additionally, and as noted above, the suitability score can constitute an overall score that is based on any number of sub-scores. According to some embodiments, a respective sub-score can be assigned to each search requirement, where the value that is assigned to the respective sub-score represents a respective strength by which relevant characteristics of the potential contingency airfield satisfies the search requirement. Additionally, the value can be adjusted based on the priority that is assigned to the search requirement. For example, continuing with the example illustrated in FIG. 2A, the search requirement for the “Runway Slop/Grade Ranges” specifies that the runway should have a slope that is less than or equal to 3%, where a 5% priority is assigned. In this regard, if the desired range of the overall score is 0-99, then the sub-score for the elevation range can take on a value of 0-4. Accordingly, if the potential contingency airfield has a runway with a 3% slope—which falls at the less desirable end of the acceptable range—then the sub-score for the elevation range can be assigned a value that is lower in the range (e.g., 2). Continuing with the example illustrated in FIG. 2A, the search requirement for the “Runway Dimension Ranges” specifies that the runway should have a length that is at least 750 m, and a width that is at least 15 m, where a 75% priority is assigned. In this regard, the sub-score for the runway dimensions can take on a value of 0-74. Accordingly, if the potential contingency airfield has a runway with a length of 1000 m and a width of 20 m—which exceed the minimum requirements by substantial margins—then the sub-score for the runway dimensions can be assigned a value that is higher in the range (e.g., 70). In any case, when the sub-scores for the search requirements have been calculated, they can be aggregated, further-processed, etc., to establish the suitability score for the potential contingency airfield.

As a brief aside, it is noted that the foregoing examples are not meant to be limiting, and that overall score, sub-scores, etc., can be generated by analyzing the search requirements, characteristics of the potential contingency airfield, etc., at any level of granularity, without departing from the scope of this disclosure. For example, different score ranges can be employed without departing from the scope of this disclosure. Moreover, respective rules can be employed for one or more of the search requirements to effectively identify a sub-score that is suitable to assign to the search requirement. In this regard, different rules can be applied when determining strengths by which a given potential contingency airfield satisfies different search requirements. Such rules can be AI-derived, developer-derived, user-derived, and so on, without departing from the scope of this disclosure. Additionally, the overall scores can be normalized based on the collection of overall scores that are returned in a set of search results. For example, if ten search results are provided, and the overall scores all fall within a few points of one another, then the overall scores can be artificially increased so that the user has a greater understanding of the differences between the overall scores.

According to some embodiments, the supplemental information can also include information that can be visually overlaid onto the respective portion of the geospatial information (e.g., bounding boxes, pins, etc., within aerial-based and/or ground-based virtual environments accessible to the application 107). This information can be generated using any feasible approach, such as by employing AI-based recognition techniques, developer-based recognition techniques, user-based recognition techniques, and so on. Additionally, the supplemental information can include a plurality of objects that are identified relative to the potential contingency airfield, such as infrastructure objects (e.g., hangars, buildings, barracks, electrical connections, water connections, gas connections, sewer connections, etc.), vehicles (e.g., aircraft, trucks, cars, trains, etc.), available transportation options (e.g., access roads, railroads, waterways, etc.), obstacles (e.g., natural obstacles such as trees, mountains, hills, ravines, etc., manmade obstacles such as antennas, towers, smokestacks, etc.), and so on. Additionally, the plurality of objects can include storage options (e.g., fuel containers, water towers, etc.), security options (e.g., fences, walls, bunkers, etc.). Additionally, the plurality of objects can include strategic locations, such as nearby structures, roads, towns, cities, and so on. Any of the aforementioned objects can be identified using any feasible approach, such as by employing AI-based recognition techniques, developer-based recognition techniques, user-based recognition techniques, and so on. 3D models for the aforementioned objects can also be generated (e.g., using any of the aforementioned techniques) to be displayed within the virtual environments described herein. It is noted that the foregoing examples are not meant to be limiting, and that the plurality of objects can identify any number, type, form, etc., of objects based on available information about the potential contingency airfield, at any level of granularity, without departing from the scope of this disclosure.

When the cloud-based computing system 116 has generated the aforementioned information (i.e., the search results, the supplemental information, etc.), the cloud-based computing system 116 can deliver at least some of the information to the application 107. The cloud-based computing system 116 can also cache any of the information to improve efficiency when generating search results for subsequent search requests that specify similar search requirements. In any case, and in turn, the application 107 can display the search results to the user, e.g., via the user interface illustrated in the conceptual diagram 230 of FIG. 2C. It is noted that, in the interest of expanding the discussion of the present embodiments, the example search results illustrated in FIG. 2C do not necessarily correspond to the search requirements illustrated and described above in conjunction with FIGS. 2A-2B.

As shown in FIG. 2C, the user interface displays search results for twelve potential contingency airfields that have been identified for a given set of search requirements. According to some embodiments, each search result can include, for the respective potential contingency airfield, an aerial image, a name, location information, description information, and an overall suitability score (e.g., generated in accordance with the techniques described herein). According to some embodiments, and as shown in FIG. 2C, each search result can include a hyperlink to view additional information about the respective potential contingency airfield. The hyperlink, when selected, can cause the application 107 to perform a variety of operations. For example, when the hyperlink for a given search result is selected, the application 107 can display an interactive map with a location pin that represents the location of the respective potential contingency airfield. The interactive map can display aerial imagery of the potential contingency airfield/its surroundings, composite imagery of the potential contingency airfield/its surrounding (e.g., 2D, 3D, etc., information that includes images, computer-generated drawings, etc.), and so on. The interactive map can also include navigational inputs (e.g., zoom level, rotation, angle, etc.), highlighted points of interest (e.g., pins for strategic locations), and so on. It is noted that the foregoing examples are not meant to be limiting, and that the interactive map can display any amount, type, form, etc., of information, at any level of granularity, without departing from the scope of this disclosure.

Additionally, and as shown in FIG. 2C, each search result can include a respective “Visit Site” button that enables users to access an aerial-based or a ground-based virtual environment associated with the respective potential contingency airfield. In this regard, when a user opts to visit the site of the first search result illustrated in FIG. 2C—the “Commercial Airport”—the application 107 can display a prompt that requests the user to specify the type of virtual environment (i.e., aerial-based, ground-based, etc.) to be accessed, settings to be applied within the virtual environment, and so on.

Additionally, the application 107 can prepopulate, suggest, etc., to the user how the virtual environment should be configured to provide a maximally informative experience for the user. For example, the application 107 can access historical viewing information associated with the user to determine whether the user typically prefers to explore potential contingency airfields in an aerial-based or ground-based virtual environment, the settings—such as default camera positions/settings, visual overlay settings, hardware settings (e.g., graphics settings, augmented/virtual reality headset settings, etc.), and so on—under which the user typically accesses virtual environments, and so on.

Additionally, the application 107 can determine, based on characteristics of the potential contingency airfield itself, the surrounding region, and so on, how the virtual environment should be configured. For example, it may be beneficial to recommend an aerial-based virtual environment when a given potential contingency airfield is surrounded by mountains, ravines, etc., in order to adequately convey the perilous characteristics of the airfield (that might not be appreciated/fully understood in a ground-based virtual environment). It is noted that the foregoing examples are not meant to be limiting, and that any amount, type, form, etc., of settings for the virtual environments, at any level of granularity, can be suggested, pre-configured, etc., based on any amount, type, form, etc., of information, at any level of granularity, without departing from the scope of this disclosure.

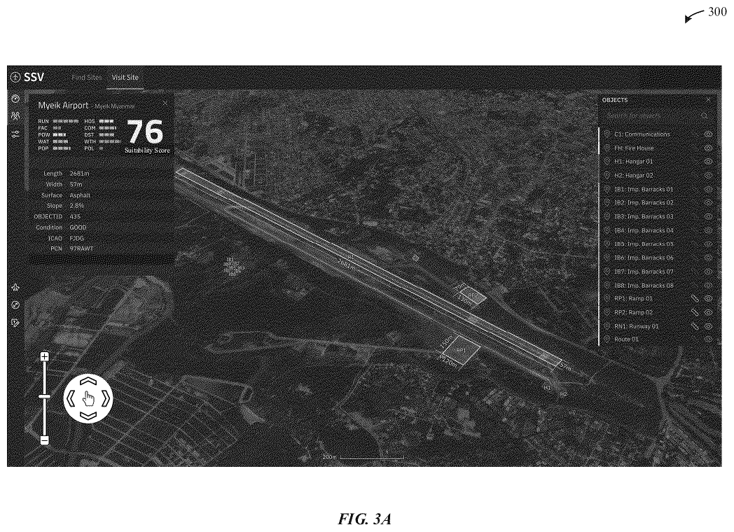

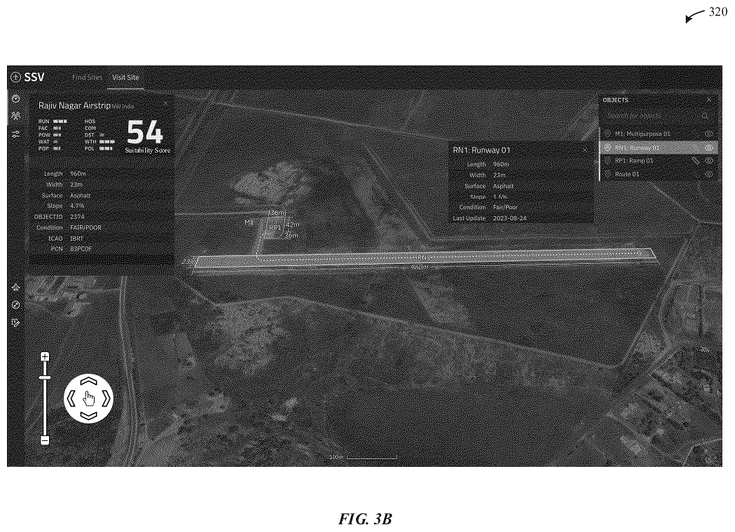

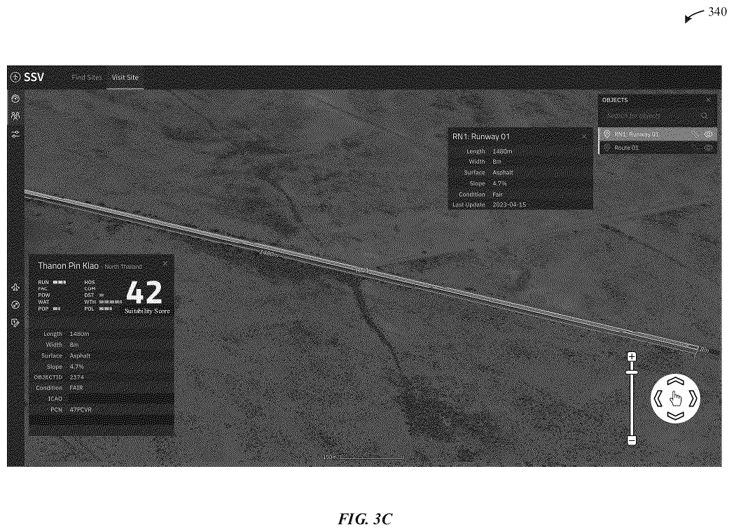

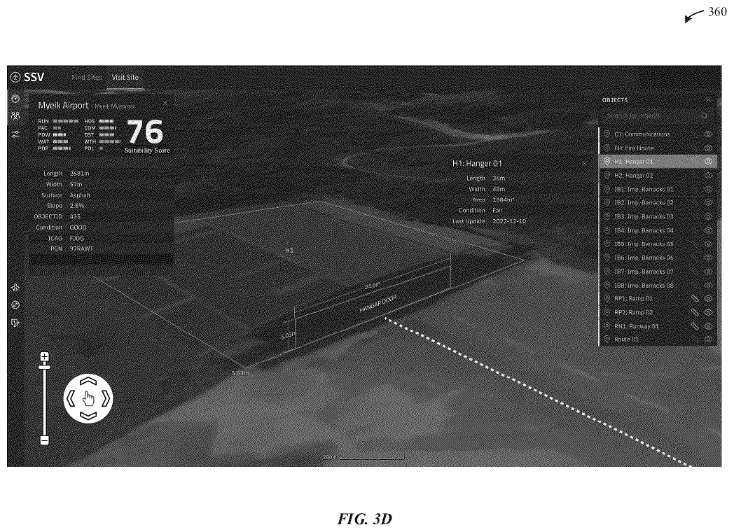

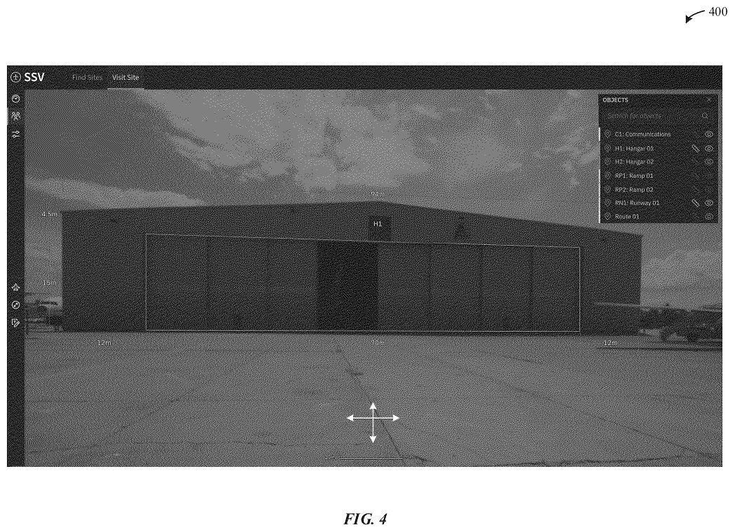

Accordingly, FIGS. 2A-2C illustrate conceptual diagrams of example search engine user interfaces that can be displayed to a user of a computing device 102 during a hypothetical engagement with the application 107, according to some embodiments. As described herein, the user can opt to access both aerial-based and ground-based virtual environments for different potential contingency airfields. To provide additional context to such environments, FIGS. 3A-3D illustrate conceptual diagrams of aerial-based virtual environments, and FIG. 4 illustrates a conceptual diagram of a ground-based virtual environment, according to some embodiments. It is noted that, in the interest of expanding the discussion of the present embodiments, the potential contingency airfields illustrated in FIGS. 3A-3D and 4 do not necessarily correspond to the search requirements and search results illustrated and described above in conjunction with FIGS. 2A-2C.

Turning now to FIG. 3A, a conceptual diagram 300—which constitutes an aerial-based virtual environment—can be displayed for a given potential contingency airfield named “Myeik Airport”, located in Myanmar. The aerial-based virtual environment can be displayed, for example, in response to a user selecting the “Visit Site” option displayed in a corresponding search result, and then opting to view the aerial-based virtual environment (e.g., instead of a ground-based virtual environment). As shown in FIG. 3A, the aerial-based virtual environment can include camera navigation controls that enable the camera to focus on a desired area. The aerial-based virtual environment can also include controls that enable the user to return back to the search results, to adjust configuration settings, to interact with objects identified at or around the potential contingency airfield, to insert virtual objects into the virtual environment, and so on. It is noted that the user interface illustrated in FIG. 3A is merely exemplary and not meant to be limiting, and that any number, type, form, etc., of user interface controls, information, etc., can be included in the user interface, at any level of granularity, without departing from the scope of this disclosure.

In the example illustrated in FIG. 3A, the potential contingency airfield has an overall suitability score of 76 that is based on, for example, a collection of sub-scores that are determined/aggregated in accordance with the techniques described herein. As shown in FIG. 3A, the user interface can include a list of acronyms for various ones of the aforementioned sub-scores. The sub-scores can include, for example, “RUN” for available runway information, “FAC” for available facility information, “POW” for available power information, “WAT” for available water information, “POP” for nearby population information, “HOS” for hostility risk information, “COM” for available communications infrastructure information, “DST” for information about distances to strategic areas, populations, etc., “WTH” for average weather information (which can be scoped, for example, to a current timeframe, a simulated timeframe, etc.), “POL” for political situation risk information, and so on. Each acronym can also be paired with a visual indicator—which takes the form of a number of blocks and a color that corresponds to the number of blocks—that visually-convey the overall value of the respective sub-score. This approach provides a benefit of effectively conveying valuable information to the user without overwhelming them with numbers.

Additionally, and as shown in FIG. 3A, the user interface can include additional information that is runway-focused. For example, the additional information can include, for a primary (or selected) runway: length/width information, surface information, slope information, condition information, pavement classification number (PCN) information, and object identifier information (e.g., relative to a set of IDs for objects identified relative to the potential contingency airfield, in accordance with the techniques described herein). The user interface can also include additional information that is airfield-focused. For example, the additional information can include an International Civil Aviation Organization (ICAO) code that is specific to the potential contingency airfield. It is noted that the foregoing examples are not meant to be limiting, and that the user interface can display any amount, type, form, etc., of information, at any level of granularity, without departing from the scope of this disclosure.

Additionally, the user interface can include information about objects of interest that are identified within the scope of the potential contingency airfield, the surrounding areas, and so on. For example, as shown in FIG. 3A, such objects include communications infrastructure, a fire house, two hangars, eight barracks, two ramps, a runway, and a potential aircraft route. According to some embodiments, and as shown in FIG. 3A, each object can be assigned a unique name. Each object can also be assigned a category-based color to enable the user to intuitively identify correspondences between bounding boxes, pins, etc., displayed within the virtual environment, and objects that are included in the list of objects. According to some embodiments, the user interface can be updated to reflect selections to display/hide objects within the user interface (e.g., using the corresponding eye icons). The user interface can also be updated to reflect selections to display/hide supplemental information for the visible objects within the user interface (e.g., using the corresponding ruler icons). As shown in FIG. 3A, the user interface displays bounding boxes around the selected objects, where each bounding box has corresponding information—such as identifying information, dimensional information, etc.—that conveys additional information about the corresponding object.

According to some embodiments, a selection of one or more objects can cause the camera of the user interface to be updated so that information about the one or more objects can be displayed in an optimal capacity. For example, when two or more objects are selected, the view (e.g., zoom level, angle, etc.) of the camera can be adjusted so that at least some of the aforementioned information associated with the two or more objects is visible within the user interface. In another example, when a single object is selected, the view of the camera can be adjusted so that the single object (and its corresponding information) is primarily displayed within the user interface (e.g., as described below in conjunction with FIG. 3D). Additionally, when a given object is selected within the virtual environment—e.g., by selecting a bounding box, by selecting information displayed in conjunction with the bounding box, etc.—the view of the camera can be adjusted so that the single object (and its corresponding information) is primarily displayed within the user interface. It is noted that the foregoing examples are not meant to be limiting, and that the view of the potential contingency airfield, the objects identified therein, the surrounding points of interest, etc., can be adjusted based on any amount, type, form, etc., of information, selections, etc., at any level of granularity, without departing from the scope of this disclosure.

Accordingly, FIG. 3A illustrates an example aerial-based virtual environment that can be displayed for a given potential contingency airfield, according to some embodiments. Additionally, FIGS. 3B-3D illustrate supplemental examples of aerial-based virtual environments that can be displayed for different potential contingency airfields, according to some embodiments. For example, FIG. 3B illustrates a conceptual diagram 320 of an aerial-based virtual environment for a given potential contingency airfield named “Rajiv Nagar Airstrip”, located in India. As shown in FIG. 3B, the user interface can include user interface elements similar to those described above in conjunction with FIG. 3A. Additionally, FIG. 3B illustrates a contextual window that can be displayed in response to selection of the runway object “RN1” in the list of objects. As shown in FIG. 3B, the contextual window can include information that is specific to the runway object “RN1”, including a length, a width, a surface material, a slope, a condition, and information about when the aforementioned information was last gathered, detected, and so on. It is noted that the information displayed within the contextual window is not meant to be limiting, and that the window can be adjusted to include any amount, type, form, etc. of information, at any level of granularity, without departing from the scope of this disclosure.

Additionally, FIG. 3C illustrates a conceptual diagram 340 of an aerial-based virtual environment for a given potential contingency airfield named “Thanon Pin Klao”, located in Thailand. As shown in FIG. 3C, the potential contingency airfield constitutes a segment of a road that the cloud-based computing system 116 has identified as having the following properties: a length of 1480 m, a width of 8 m, a slope of 4.7%, a surface material of asphalt, and a condition of “fair”, where such properties were last detected/determined on a particular date. As shown in FIG. 3C, the aerial-based virtual environment includes appropriate user interface elements that enable the user to explore the potential contingency airfield, consistent with the techniques discussed herein.

Additionally, FIG. 3D illustrates a conceptual diagram 360 of the aerial-based virtual environment for the potential contingency airfield “Myeik Airport” (described above in conjunction with FIG. 3A). However, as shown in FIG. 3D, the camera view is primarily focused on the hangar “Hangar 01”. The camera view can be activated, for example, by double-clicking on the object in the object list that corresponds to the aforementioned hangar, by double-clicking on the object within the virtual environment, and so on. According to some embodiments, and as shown in FIG. 3D, the user interface can be updated to display bounding boxes that correspond to the camera view, as well as the orientation, characteristics, etc., of the aforementioned hangar. For example, the bounding boxes can traverse the salient edges of the hangar to highlight the overall dimensions of the hangar, the access doors included on the hangar, and so on. The user interface can also display measurement information that complements one or more of the aforementioned measurements. The information can also identify complementary features that are salient to the hangar, such as routes to the hangar, square footage metrics associated with the hangar, names for different aspects of the hangar (e.g., “Hangar Door”, “Hangar Side Door”, “Hangar Roof”, etc.). It is noted that the information illustrated in FIG. 3D should not be construed as limiting, and that any amount, type, form, etc., of information, at any level of granularity, can be incorporated into object-specific views of the aerial-based virtual environments, without departing from the scope of this disclosure.

Accordingly, FIGS. 3A-3D illustrate example user interfaces that can be incorporated into different aerial-based virtual environments, according to some embodiments. As previously described herein, the application 107 can also enable the user to access ground-based virtual environments for potential contingency airfields. Such ground-based virtual environments can be accessed using a variety of approaches. For example, the user can choose to view a ground-based virtual environment in conjunction with selecting the “Visit Site” option presented for a given potential contingency airfield. In another example, the user can choose the ground-based virtual environment while accessing an aerial-based virtual environment, e.g., by selecting from different view options included in the ground-based virtual environment. In yet another example, the ground-based virtual environment can be activated when the user zooms to a maximum level within the aerial-based virtual environment.

In any case, FIG. 4 illustrates a conceptual diagram 400 of an example ground-based virtual environment, according to some embodiments. As shown in FIG. 4, the ground-based virtual environment enables the user to experience the potential contingency airfield as if they were physically onsite and able to move around. The user can traverse the potential contingency airfield using a variety of input techniques, such as mouse-based inputs (e.g., using the navigational arrows illustrated in FIG. 4), keyboard-based inputs, gesture-based inputs, and so on. According to some embodiments, and as shown in FIG. 4, the ground-based virtual environment includes bounding boxes for relevant objects that are detected in association with the potential contingency airfield. According to some embodiments, the bounding boxes can be dynamically displayed for objects as they come into view within the ground-based virtual environment.

Additionally, and according to some embodiments, the ground-based virtual environment (and/or a given aerial-based virtual environment) can enable the user to insert virtual objects having sizes that are scaled in accordance with the current view, the surrounding objects, and so on. For example, in FIG. 4, the user can be permitted to select, e.g., by clicking the airplane icon on the middle/left side of the user interface, an option to view a list of 3D aircraft objects that, when dragged into the virtual environment, will be rendered (according to the aforementioned techniques) to thereby enable the user to achieve an intuitive understanding about the aircraft accommodation capabilities of the potential contingency airfield. It is noted that the foregoing examples are not meant to be limiting, and that any amount, type, form, etc., of virtual objects can be inserted into the virtual environments described herein, at any level of granularity, without departing from the scope of this disclosure.

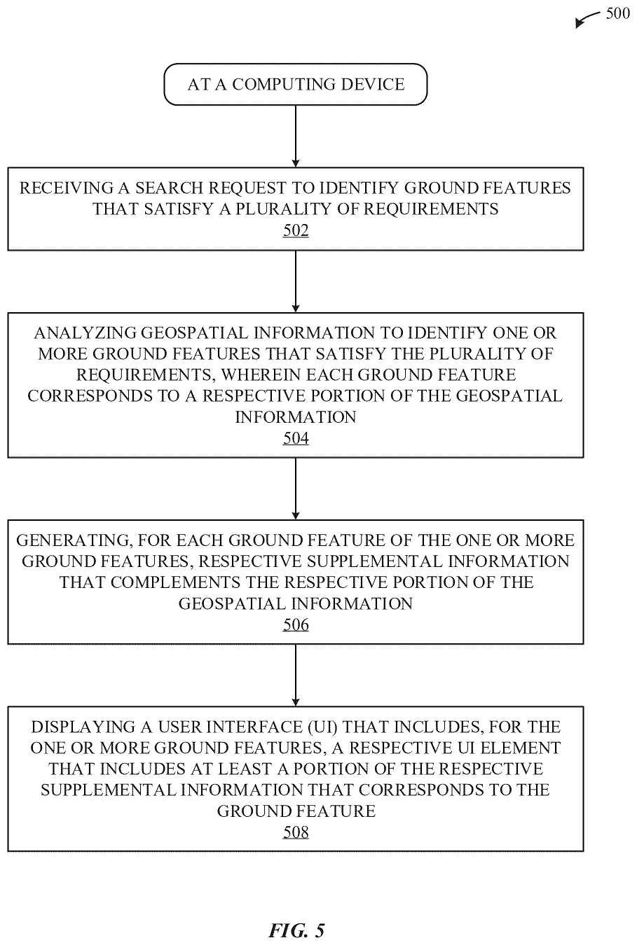

FIG. 5 illustrates a method 500 for identifying ground features and enabling virtual interactions therewith, according to some embodiments. As shown in FIG. 5, the method 500 begins at step 502, where a computing device—such as one or more servers 128, computing devices 102, etc. —receives a search request to identify ground features that satisfy a plurality of requirements (e.g., as described above in conjunction with FIGS. 1-2, 3A-3D, and 4-5). At step 504, the computing device analyzes geospatial information to identify one or more ground features that satisfy the plurality of requirements, wherein each ground feature corresponds to a respective portion of the geospatial information (e.g., as also described above in conjunction with FIGS. 1-2, 3A-3D, and 4-5).

At step 506, the computing device generates, for each ground feature of the one or more ground features, respective supplemental information that complements the respective portion of the geospatial information (e.g., as also described above in conjunction with FIGS. 1-2, 3A-3D, and 4-5). At step 508, the computing device displays a user interface (UI) that includes, for the one or more ground features, a respective UI element that includes at least a portion of the respective supplemental information that corresponds to the ground feature (e.g., as also described above in conjunction with FIGS. 1-2, 3A-3D, and 4-5).

FIG. 6 illustrates an example computer system 600, which can perform any one or more of the methods described herein. In one example, computer system 600 may correspond to the computing device 102, the one or more servers 128 of the cloud-based computing system 116, etc., described above in conjunction with FIG. 1. The computer system 600 may be capable of executing the application 107 (e.g., the video game) of FIG. 1. The computer system 600 may be connected (e.g., networked) to other computer systems in a LAN, an intranet, an extranet, or the Internet. The computer system 600 may operate in the capacity of a server in a client-server network environment. The computer system 600 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), solid state drive (SSD), flash memory, dynamic random-access memory (DRAM) such as synchronous DRAM (SDRAM)), a static memory 606 (e.g., solid state drive (SSD), flash memory, static random-access memory (SRAM)), and a data storage device 608, which communicate with each other via a bus 610.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions for performing any of the operations and steps discussed herein.

The computer system 600 may further include a network interface device 612. The computer system 600 also may include a video display 614 (e.g., a liquid crystal display (LCD) or a cathode ray tube (CRT)), one or more input devices 616 (e.g., a keyboard and/or a mouse), and one or more speakers 618 (e.g., a speaker). In one illustrative example, the video display 614 and the input device(s) 616 may be combined into a single component or device (e.g., an LCD touch screen).

The data storage device 608 may include a computer-readable medium 620 on which the instructions 622 (e.g., implementing the application 107, and/or any component depicted in the FIGURES and described herein) embodying any one or more of the methodologies or functions described herein are stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over a network via the network interface device 612.

While the computer-readable medium 620 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

One embodiment sets forth a method for identifying ground features and enabling virtual interactions therewith. According to some embodiments, the method can be implemented by a computing device, and includes the steps of (1) receiving a search request to identify ground features that satisfy a plurality of requirements, (2) analyzing geospatial information to identify one or more ground features that satisfy the plurality of requirements, wherein each ground feature corresponds to a respective portion of the geospatial information, (3) generating, for each ground feature of the one or more ground features, respective supplemental information that complements the respective portion of the geospatial information, and (4) displaying a user interface (UI) that includes, for the one or more ground features, a respective UI element that includes at least a portion of the respective supplemental information that corresponds to the ground feature.

According to some embodiments, the plurality of requirements includes, for the ground features, specifications of geographical regions, surface dimension ranges, surface materials, surface slope/grade ranges, a surface condition range, an elevation range, obstacle clearance ranges, available storage options, available security options, available infrastructure options, available transportation options, distance ranges to strategic locations, or some combination thereof.

According to some embodiments, for a given ground feature, the respective UI element includes the following overview information included in the respective supplemental information: an aerial image of the ground feature, a name for the ground feature, location information for the ground feature, description information that at least pertains to how the ground feature satisfies the plurality of requirements, a suitability score that is based at least in part on an overall strength by which the ground feature satisfies the plurality of requirements, or some combination thereof.

According to some embodiments, the method further comprises (1) receiving a selection to provide an aerial-based virtual interaction with a particular ground feature of the one or more ground features, (2) generating an aerial-based virtual environment in which at least a second portion of the respective supplemental information is visually overlaid onto the respective portion of the geospatial information, and (3) displaying the aerial-based virtual environment.

According to some embodiments, the method further comprises (1) receiving a second selection to provide a ground-based virtual interaction with the particular ground feature, (2) generating a ground-based virtual environment in which at least a third portion of the respective supplemental information is visually overlaid onto the respective portion of the geospatial information, and (3) displaying the ground-based virtual environment.

According to some embodiments, the aerial-based virtual environment and/or the ground-based virtual environment displays: (1) at least a portion of the overview information, (2) at least one requirement of the plurality of requirements, along with at least one corresponding value, obtained from the respective portion of the geospatial information, that satisfies the at least one requirement, and (3) a listing of a plurality of objects identified within the ground feature, wherein, when an object is selected, the computing device displays, within the user interface, secondary overview information pertaining to the object.

According to some embodiments, the visually-overlaid second and third portions of the respective supplemental information include: (1) a respective bounding box for at least one object of a plurality of objects identified within the ground feature, wherein at least one edge of the respective bounding box is accompanied by a respective dimensional measurement, and (2) at least one name for at least one object of the plurality of objects.

According to some embodiments, the method further comprises receiving a request to establish, within the ground-based virtual environment, at least one artificial object having dimensions that coincide with those of the ground-based virtual environment.

According to some embodiments, (1) the one or more ground features are also identified based on airport/facility directory (AFD) documents and/or chart supplements, and/or (2) the respective supplemental information generated for the one or more ground features is based on airport/facility directory (AFD) documents and/or chart supplements.

According to some embodiments, the geospatial information comprises photogrammetry information derived from aerial-based and/or ground-based images of different areas of the surface of the Earth, and the ground features comprise manufactured features and/or naturally-occurring features.

In some examples, preflight operations may include planning pilots and aircraft routes to determined airfields at determined destinations. However, preflight operations may also include planning for emergency situations, such as when pilots need to perform landings at contingency landing sites. For example, it may be prudent to identify contingency landing sites along the flight path to the destination in case of an emergency and the pilot needs to perform an emergency landing. The disclosed techniques may enable identifying and providing guidance to the pilot's computing device prior to the pilot flying and/or in real-time or near real-time while the pilot is midair flying the aircraft. In some embodiments, the computing device may execute an artificial intelligence engine with trained computer-implemented models to determine the contingency landing sites that are suitable for landing the aircraft without communicating with any other devices (e.g., server), which may be particularly beneficial in cases where communications of the aircraft have failed or been disabled for some reason.

In some embodiments, the artificial intelligence engine may receive each relevant satellite imagery associated with or underlying a flight plan. The artificial intelligence engine may, in the event of an emergency, identify a contingency landing site “on the fly” or in real-time/near real-time. In some embodiments, the computer-implemented models that have been trained may identify and/or generate sub-optimal contingency landing sites based on real-time information, such as altitude, airspeed, engine thrust, etc. that the artificial intelligence engine may not have access to during preplanning phase. That is, dynamic planning may be enabled for a contingency/expedient landing site based on characteristics of the aircraft in real-time or near real-time while the aircraft is flying. In another embodiment, the artificial intelligence engine may identify a suitable “crash landing” or contingency landing site based on current, real-time conditions (and may presume there is not time or altitude to reach a real (e.g., built cement or dirt) runway.

Further, the disclosed embodiments may provide a software application that enables conducting remote, real-time AI-supported airfield surveys and virtual site visits of potential expedient airfields across the breadth of the globe to support rapid aircraft deployments. The disclosed embodiments may include one or more servers communicatively coupled to various public and/or secure data sources to identify, evaluate, prioritize, and simulate aircraft landing sites across a range of user-generated criteria (e.g., location, length, and obstacles) providing an aviator or mission planner with a powerful, flexible application to support operations. Some embodiments may include a real-time or near real-time search engine for contingency airfields or landing sites by leveraging computer vision, generative artificial intelligence (AI) and satellite imagery to accelerate the site survey process, which may enable users to conduct “virtual site surveys” and expand options to include unimproved sites (such as roads or fields).

Some embodiments of this disclosure may provide answers to whether particular airfields are appropriate for a specific mission and aircraft type by generating a unique score of suitability (e.g., “78”) supported by component scores (e.g., runway length, obstacles, distance to target), and “pass/fail” scores, all customizable by the user. In such a way, the disclosed techniques may transform opinions of suitability into a measurable objective ranking allowing for rapid decision making. Further, the disclosed techniques may increase the number of evaluated locations due to the automated nature of assessing large and under-utilized areas to increase a commander's decision space.

In addition, users that use the disclosed AI-enabled software application may provide support to other personnel by making multiple queries in real-time or near real-time based on customizable criteria and drilling down into the database of potential locations to find suitable operating locations. The disclosed techniques may include austere locations such as highways and fields as potential contingency landing sites during the planning phase and/or during flight of a mission. Further, the software application may also account for infrastructure of a landing surface, support facilities, access to fuel, bed down locations, and the like when making a suitability determination of various contingency landing sites. In some embodiments, the disclosed software application may retrieve data from public and other sources to identify and document supporting resources (such as distance to nearby hotels, gas stations, or a beach suitable for a roll on/roll off ships along with the suitability of adjoining roads) critical to the total mission of a team executing maneuver warfare to survive adversary attacks while generating combat power.

In some embodiments, the disclosed techniques may enable a user to query a database and the software application may execute an artificial intelligence engine to generate a list of potential contingency landing sites in real-time, along with a selection of representational images and a customized, multi-factor suitability score and confidence score for each location. Once a potential location is selected, the software application may execute generative AI to produce a high-fidelity, interactive 3D model of the landing site which allows users to perform a virtual “on the ground” site survey of operating locations to view obstacles such as power lines, crumbling taxiways, or mountainous terrain to inform critical safety decisions.

In some embodiments, the software application may use a database that incorporates a living library of satellite imagery (sourced from public and private sources) into a database of airfields and contingency landing sites. Further, the software application may execute a search engine that enables a user to query the database to identify existing and non-traditional airfields and receive a listing of potential landing sites. Further, the software application may determine rank scores. Based on criteria selected by the user and/or the artificial intelligence engine, the software application may score each identified landing site across both established criteria and user-generated criteria, providing a cumulative score, and scores for categories (e.g., such as length and width). In addition, the disclosed software application may provide a user interface using generative artificial intelligence (e.g., photogrammetry) and use multiple overhead and perspective two-dimensional (2D) airfield location images to generate 3D models. The users can then “fly through” or “walk through” the location to assess obstacles, aircraft parking ramps, bed down and facilities, all displayed with interactive visual elements (e.g., such as measurements). In some embodiments photogrammetry converts 2D images to 3D data and geometry and common features are detected across multiple images to serve as referenced points and allow the images to be matched together. A point cloud may be generated from calculating 3D coordinates from common features. A 3D surface mesh may be generated and then applied to the 3D model, and the 3D model may be output to a user interface of a simulation software application disclosed here. The images may be retried from various sources such as National Geospatial Intelligence Agency, DigitalGlobe, Planet Labs, OpenStreet Map, Federal Aviation Administration, and others.

In some embodiments, the artificial intelligence engine may train one or more computer-implemented models to identify runways at traditional airports and non-traditional runways like roads, grassy fields, etc. In addition, The artificial intelligence engine may execute cutting-edge segmentation AI to identify the pixels of the “runways” and/or contingency landing sites in the images. In some embodiments, training data may be generated using using existing small and large airfields from around the globe, as well as roads that were designed to land airplanes. Once trained, the AI models produces weights that can be used in future AI models and used to configure other AI models. The trained computer-implemented models may then be used by inputting satellite data images with five light spectrums to find pixels and identify the runway and/or contingency landing site by using visual elements associated with each pixel of the identified runway and/or contingency landing site. The generated results may be stored in a searchable database, which is used by a front end user interface of the software application disclosed herein to query the database and identify contingency landing sites.

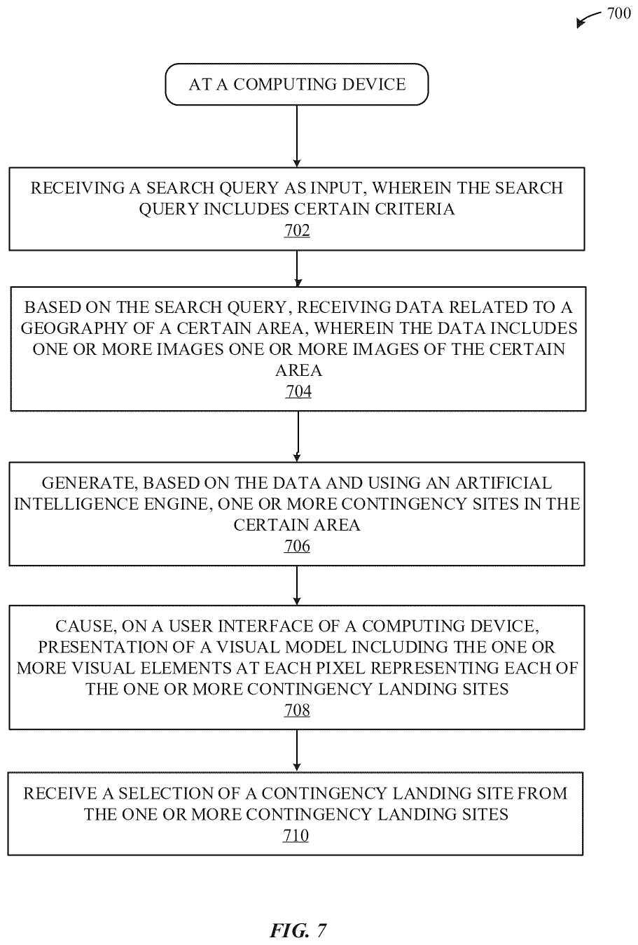

FIG. 7 a method 700 for identifying contingency landing sites and enabling virtual interactions therewith, according to some embodiments according to certain embodiments of this disclosure. The method 700 is performed by processing logic that may include hardware (circuitry, dedicated logic, etc.), software (such as is run on a computer system or specialized dedicated machine), or a combination of both. The method 700 or each of their individual functions, routines, subroutines, or operations may be performed by one or more processors of a computing device (e.g., any component of FIG. 1, such as computing device 102, server 128 executing the artificial intelligence engine 140, etc.). In certain implementations, the method 700 may be performed by a single processing thread. Alternatively, the method 700 may be performed by two or more processing threads, each thread implementing one or more individual functions, routines, subroutines, or operations of the methods. In some embodiments, one or more accelerators may be used to increase the performance of a processing device by offloading various functions, routines, subroutines, or operations from the processing device. One or more operations of the method 700 may be performed by the training engine 131 of FIG. 1.

For simplicity of explanation, the method 700 is depicted and described as a series of operations. However, operations in accordance with this disclosure can occur in various orders or concurrently, and with other operations not presented and described herein. For example, the operations depicted in the method 700 may occur in combination with any other operation of any other method disclosed herein. Furthermore, not all illustrated operations may be required to implement the method 700 in accordance with the disclosed subject matter. In addition, those skilled in the art will understand and appreciate that the method 700 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At step 702, the processing device may receive a search query as input. The search query may include certain criteria. The certain criteria may include at least one of an airfield length, an airfield width, a geographic location, a desired facility, a type of aircraft, a length of the aircraft, a width of the aircraft, or some combination thereof.

At step 704, based on the search query, the processing device may receive data related to a geography of a certain area. The data may include one or more images of the certain area. The images may include aerial images (e.g., satellite images) and/or ground images.

At step 706, the processing device may generate, based on the data and using the artificial intelligence engine 140, one or more contingency landing sites in the certain area. Each of the one or more contingency landing sites may include at least a suitability score determined based on the certain criteria. The artificial intelligence engine 140 may be trained via tailored weights to identify each pixel associated with each of the one or more contingency landing sites in the images and to use one or more visual elements at each pixel to represent each of the one or more contingency landing sites in a visual model.

In some embodiments, the artificial intelligence engine 140 may include one or more computer-implemented models (e.g., machine learning models 132) that are trained with training data including inputs including at least a corpus of images (e.g., satellite), geographic features, obstacles, objects, elements, weather conditions, aircraft types, maintenance capabilities, munition availability fuel availability, runway or airway lengths, runway or airway widths, aircraft lengths, aircraft widths, or some combination, and outputs including at least the one or more contingency landing sites, one or more suitability scores, one or more confidence scores, or some combination thereof. In some embodiments, the computer-implemented models may be segmentation artificial intelligence trained to segment various wavelengths (e.g., 1, 2, 3, 4, 5, 6, etc.) in a spectrum of light included in images. For example, the segmentation artificial intelligence models may be able to segment pixels and identify which pixels are associated with a contingency landing site, runway, and the like. The identified pixels may be stored in a database 129 with other images also classified as having pixels associated with one or more contingency landing sites. The database 129 may include one or more data structures that stores the images labeled with pixels identifying contingency landing sites. A pilot and/or mission manager and the like may query the database 129 pre-flight to plan where the pilot may land in case of an emergency along a route to a destination. In some embodiments, the database 129 may be downloaded to the computing device of the pilot and the pilot may query the database 129 in real-time or near real-time to determine a contingency landing site while the pilot is flying the aircraft.

In some embodiments, the one or more computer-implemented models (e.g., machine learning models 132) may be configured using weights determined via the server by the server training computer-implemented models (e.g., machine learning models 132) to identify pixels representing contingency landing sites. Due to the size of the data being processed and the resources consumed to train one or more neural networks of the computer-implemented models, the training may be performed on the server that has larger processing capabilities and/or memory capabilities than the computing device (e.g., smartphone, tablet, laptop, etc.). The server may be remotely located from the computing device of the user. For example, in some embodiments, the computing device may be located with the pilot in an aircraft flying miles above the earth and the server may be located in a data warehouse. Once trained, the server may transmit the weights and/or other parameters to the computing device executing the computer-implemented models locally on the computing devices, and the computing devices may configure the computer-implemented models with the weights and/or the other parameters. In some embodiments, the artificial intelligence may include one or more computer-implemented models trained with training data including a length of an airway, a width of an airway, a type of aircraft, or some combination thereof.

In some embodiments, as the computing device receives information from various sensors and/or other sources, the computing device may transmit the sensor data and/or other information back to the server for the server to retrain the one or more computer-implemented models. For example, using computer vision and/or cameras, the aircraft and/or computing device may take updated images of an area associated with the contingency landing site and transmit the updated images to the server to retrain the computer-implemented models.

At step 708, the processing device may cause, on a user interface of a computing device, presentation of the visual model including the one or more visual elements at each pixel representing each of the one or more contingency landing sites.

In some embodiments, based on the suitability score of each of the one or more contingency landing sites, the processing device may rank the one or more contingency landing sites into a ranked list. For example, the higher the suitability score, the more prominently the associate contingency landing site may be presented on a user interface as opposed to a contingency landing site having a lower suitability score. More prominently displayed contingency landing sites having higher suitability scores may have a higher probability of being selected by a pilot and/or flight planner because they satisfy more desired criteria than contingency landing sites having lower suitability scores that satisfy less desired criteria. In some embodiments, ranking and prominently displaying the most suitable contingency landing sites may save computing resources because they user may select one of the displayed highly ranked contingency landing sites without scrolling down to see other contingency landing sites or clicking a “next” button to see additional contingency landing sites (thereby causing less calls to be made to the server to load additional contingency landing sites). These techniques may be especially technically beneficial on computing devices with small display screens, such as smartphones and/or tablets, where the visual real estate is limited and only a few contingency landing sites may be presented at a time on a user interface.

At step 710, the processing device may receive a selection of a contingency landing site from the one or more contingency landing sites. In some embodiments, based on the selected contingency landing site, the processing device may control operation of an aircraft, in real-time or near real-time, to navigate from a current location of the aircraft to the contingency landing site and to land at the contingency landing site. In some embodiments, one or more computer-implemented models (e.g., machine learning models 132) may be trained with inputs including various images (e.g., maps), obstacles (e.g., trees, power lines, boulders, terrain, buildings, terrain, etc.), weather conditions, and the like, as well as information pertaining to the aircraft (e.g., type, width, length, weight, engine, etc.) to output a navigational route including operating parameters (e.g., speed, rudder angle, power usage, tilt, aircraft orientation, etc.) to control the aircraft to fly to the selected contingency landing site and land the aircraft. The operating parameters may control an engine of the aircraft, landing gear of the aircraft, brakes of the aircraft, portions (e.g., wings, propeller, etc.) of the aircraft, and the like.

In addition, in some embodiments, the processing device may generate, using the images, a 3D model of the selected contingency landing site. The 3D model may include visual elements representing obstacles, power lines, terrain, objects, weather conditions, or some combination thereof. In some embodiments, the processing device may cause presentation of the 3D model on a computing device of an air ambulance representative, wherein the air ambulance representative may be enabled to provide, in real-time or near real-time, instructions to a pilot of the air ambulance on landing instructions at an identified location in the 3D model. In some embodiments “real-time” may refer to less than 2 seconds, and “near real-time” may refer to between 2 and 20 seconds.

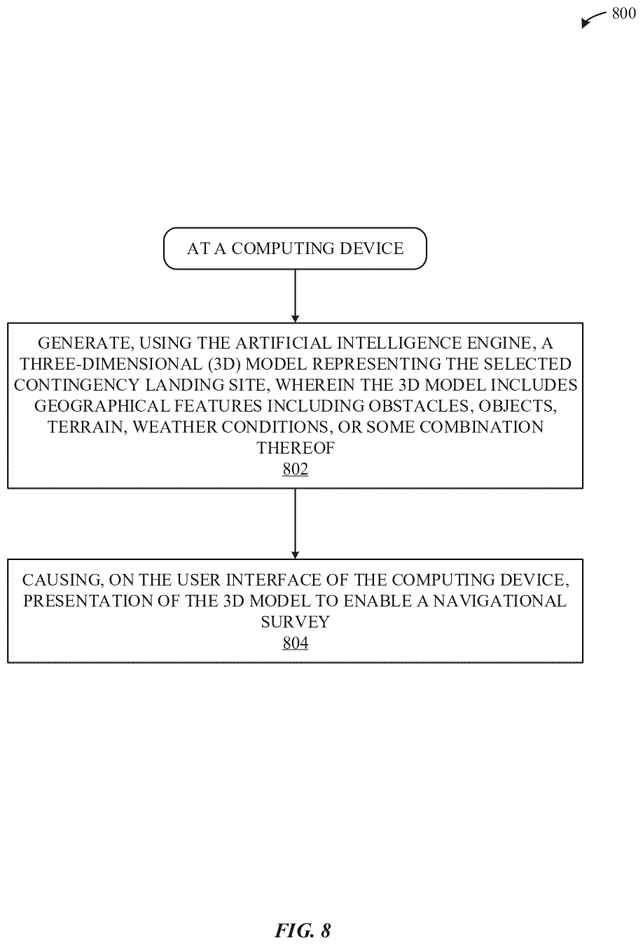

FIG. 8 illustrates a method 800 for generating a three-dimensional (3D) model of a selected contingency landing site, according to some embodiments. The method 800 is performed by processing logic that may include hardware (circuitry, dedicated logic, etc.), software (such as is run on a computer system or specialized dedicated machine), or a combination of both. The method 800 or each of their individual functions, routines, subroutines, or operations may be performed by one or more processors of a computing device (e.g., any component of FIG. 1, such as computing device 102, server 128 executing the artificial intelligence engine 140, etc.). In certain implementations, the method 800 may be performed by a single processing thread. Alternatively, the method 800 may be performed by two or more processing threads, each thread implementing one or more individual functions, routines, subroutines, or operations of the methods. In some embodiments, one or more accelerators may be used to increase the performance of a processing device by offloading various functions, routines, subroutines, or operations from the processing device. One or more operations of the method 800 may be performed by the training engine 131 of FIG. 1.

For simplicity of explanation, the method 800 is depicted and described as a series of operations. However, operations in accordance with this disclosure can occur in various orders or concurrently, and with other operations not presented and described herein. For example, the operations depicted in the method 800 may occur in combination with any other operation of any other method disclosed herein. Furthermore, not all illustrated operations may be required to implement the method 800 in accordance with the disclosed subject matter. In addition, those skilled in the art will understand and appreciate that the method 700 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At step 802, the processing device generate, using the artificial intelligence engine 140, a three-dimensional (3D) model representing the selected contingency landing site. The 3D model may include geographical features including obstacles, objects, buildings, weather conditions, or some combination thereof.

At step 804, the processing device may cause, on the user interface of the computing device, presentation of the 3D model to enable a navigational survey. The navigational survey may include presenting a virtual avatar or character on the user interface that the user may control to walk around within 3D model to enter and exit various buildings, to examine obstacles, to traverse various portions of the runway/airway, and the like. In some embodiments, the navigational survey may allow a user to select, using an input peripheral, on various portions of a user interface for focus to be adjusted to the selected portion of the 3D model that is associated with the selection. For example, the user may select a building and the focus of the user interface may be moved to the building and additional details (e.g., width, height, contents, etc.) of the building may be presented in a visual element overlaid over a portion of the 3D model in the user interface.

In some embodiments, the user may select a location displayed in the 3D model to zoom in or zoom out and to inspect various characteristics of the selected location. Such techniques may enable a user to determine whether the location is suitable for an air ambulance to land. For example, the user may obtain details of the selected location, such as a width, length, circumference, and the like to determine if the physical location is large enough for an air ambulance to land. In addition, due to the 3D nature of the virtual model, the user may determine if there are any potential hazards present at the selected location. In some examples, the potential hazards may only be identified via the 3D model, such as potholes in the pavement or runway, excessive debris (e.g., hay) present that could be sucked up by an engine or propeller of the aircraft, large rocks and/or uneven terrain present at the location, and the like. The 3D model may enable an operator to examine the location and provide instructions to an air ambulance pilot to land safely at the location.

In some embodiments, the artificial intelligence engine may be trained to analyze the 3D model and identify a suitable location for an air ambulance to land. The artificial intelligence engine may process and evaluate the 3D model to determine the obstacles, risks, buildings, and the like, and to provide precise instructions to a pilot of an air ambulance in real-time or near real-time as the conditions, terrain, obstacles, and the like change while the air ambulance is landing to enable the air ambulance to safely land at the selected location.

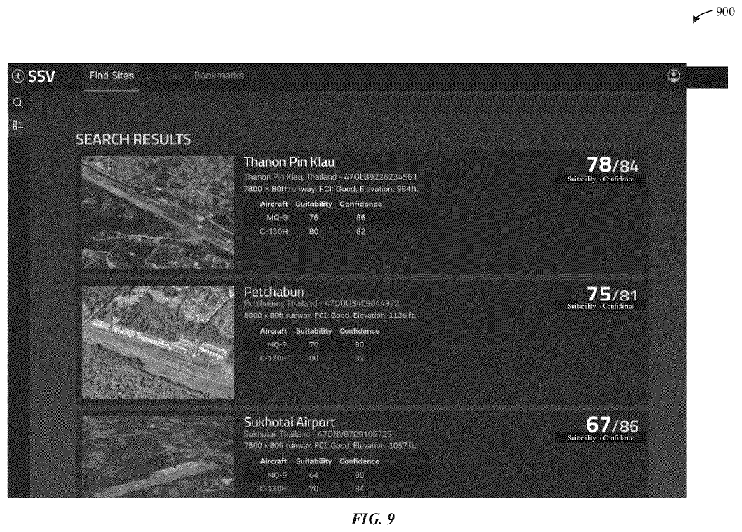

FIG. 9 illustrates a conceptual diagram of a search engine user interface 900 including suitability and confidence scores for each contingency landing site, according to some embodiments. According to some embodiments, each search result can include, for the respective potential contingency airfield (also referred to as a contingency landing site herein), an aerial image, a name, location information, description information, an overall suitability score (e.g., generated in accordance with the techniques described herein), and a confidence score (e.g., generated in accordance with the techniques described herein). According to some embodiments, and as shown in FIG. 9, each search result can include a hyperlink to view additional information about the respective potential contingency airfield. The hyperlink, when selected, can cause the application 107 to perform a variety of operations. For example, when the hyperlink for a given search result is selected, the application 107 can display an interactive map with a location pin that represents the location of the respective potential contingency airfield. The interactive map can display aerial imagery of the potential contingency airfield/its surroundings, composite imagery of the potential contingency airfield/its surrounding (e.g., 2D, 3D, etc., information that includes images, computer-generated drawings, etc.), and so on. The interactive map can also include navigational inputs (e.g., zoom level, rotation, angle, etc.), highlighted points of interest (e.g., pins for strategic locations), and so on. It is noted that the foregoing examples are not meant to be limiting, and that the interactive map can display any amount, type, form, etc., of information, at any level of granularity, without departing from the scope of this disclosure.

Additionally, the application 107 can prepopulate, suggest, etc., to the user how the virtual environment should be configured to provide a maximally informative experience for the user. For example, the application 107 can access historical viewing information associated with the user to determine whether the user typically prefers to explore potential contingency airfields in an aerial-based or ground-based virtual environment, the settings—such as default camera positions/settings, visual overlay settings, hardware settings (e.g., graphics settings, augmented/virtual reality headset settings, etc.), and so on—under which the user typically accesses virtual environments, and so on.

Additionally, the application 107 can determine, based on characteristics of the potential contingency airfield itself, the surrounding region, and so on, how the virtual environment should be configured. For example, it may be beneficial to recommend an aerial-based virtual environment when a given potential contingency airfield is surrounded by mountains, ravines, etc., in order to adequately convey the perilous characteristics of the airfield (that might not be appreciated/fully understood in a ground-based virtual environment). It is noted that the foregoing examples are not meant to be limiting, and that any amount, type, form, etc., of settings for the virtual environments, at any level of granularity, can be suggested, pre-configured, etc., based on any amount, type, form, etc., of information, at any level of granularity, without departing from the scope of this disclosure.

The various contingency landing sites presented may be identified by the artificial intelligence engine based on various criteria selected by the user and/or selected automatically. For example, if the user is flying and determines there is an emergency situation that requires the user to land the aircraft immediately, the user may select a button on a user interface of the application 107 to search for the most suitable contingency landing sites. The artificial intelligence engine may use various criteria such as a geographical location (e.g., determined via global positioning system (GPS) data) of the aircraft, length of the aircraft, width of the aircraft, length of runway needed for the type of aircraft, and so forth. The artificial intelligence engine may identify three contingency landing sites, such as the ones presented in FIG. 9. The contingency landing sites may be ranked from most suitable (e.g., Thanon Pin Klau with suitability score of 78) to least suitable (e.g., Sukhotai Airport with suitability score of 67).

Further, the artificial intelligence engine may determine confidence scores for each of the contingency landing sites. For example, one or more computer-implemented models of the artificial intelligence engine may be trained to output a confidence score which is based on the data available related to the contingency landing sites. The artificial intelligence engine may analyze images related to the contingency landing sites and if the image quality is poor, the confidence score will be low. If the image quality is high, then the confidence score will be high. Other factors may influence the confidence score, such as weather conditions at the time the search is made. For example, if the weather conditions are poor and there is a large thunderstorm or hurricane present at the contingency landing site, the confidence score may be lower because the images that are being analyzed may not be accurate if there is damage recently caused to the geographical features of the contingency landing site. In some embodiments, even when a contingency landing site has a higher suitability score than another contingency landing site, the user may select the other contingency landing site if the confidence score is higher because the user may prefer to know with a higher degree of confidence that the data used to identify and determine the suitability of the contingency landing site is accurate.

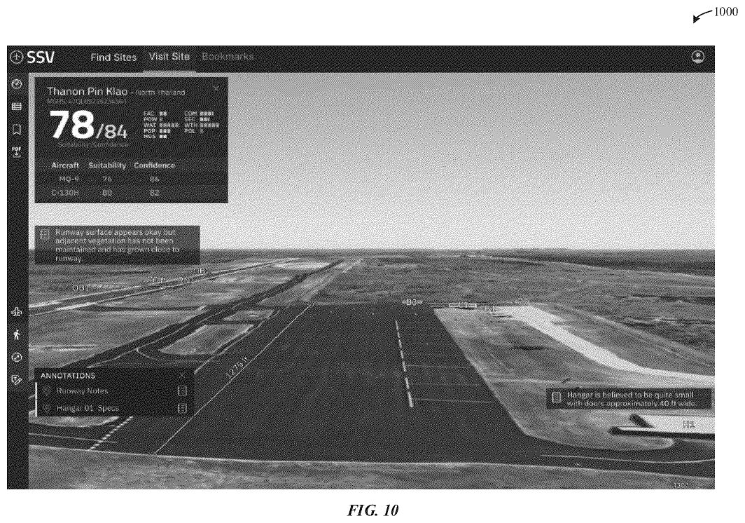

FIG. 10 illustrates a conceptual diagram of a 3D model 1000 including annotations and measurements overlaid on a contingency landing site, according to some embodiments. As depicted, a user of add, edit, and/or delete annotations to the 3D model 1000. The annotations presented include “Runway Notes” and “Hangar 01 Specs”. The notes for the runway depict that “Runway surface appears okay but adjacent vegetation has not been maintained and has grown close to the runway.” The portions of the adjacent vegetation is labeled in the diagram with diagonal lines within a square at OB1 and OB2. Further, the hangar notes indicate that “Hangar is believed to be quite small with doors approximately 40 ft. wide. ” Thus, a user flying an aircraft that has an aircraft that is wider than 40 feet, may not select to land at this contingency landing site if parking the aircraft in a hangar is of high importance. Instead, the user may specify in a search that the user desires a hangar with at least a 60 foot wide door to enable parking the aircraft inside the hangar.

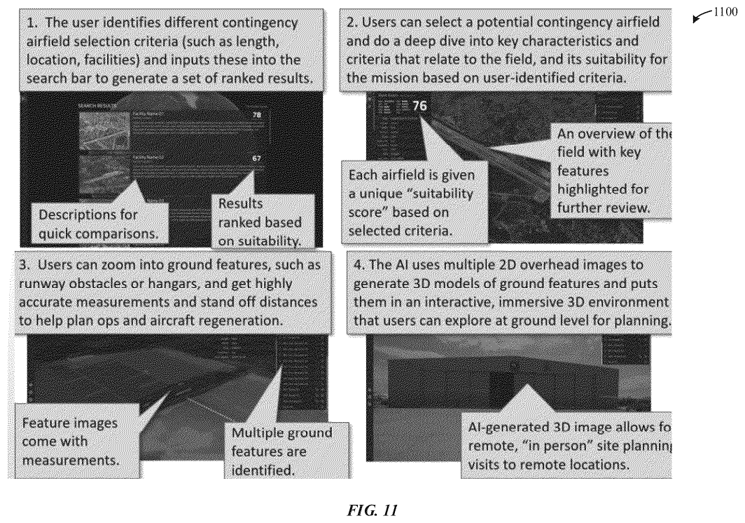

FIG. 11 illustrates a conceptual diagram 1100 including multiple user interface examples of an AI-generated 3D visual model of a selected contingency landing site that enables a user to walkthrough and confirm its suitability for desired criteria, according to some embodiments. The diagram 1100 is divided into four separate boxes each representing a different step in the process. In the first block, at step “1.”, the diagram 1100 depicts that the user identifies different contingencies airfield selection criteria (such as length, location, facilities) and inputs those into the search bar to generate a set of ranked results (e.g., ranked contingency landing sites). As depicted, the user interface that is displayed includes descriptions of each of the identified contingency landing sites and results that are ranked based on the suitability scores.

In the second block, at step “2.”, the diagram 1100 depicts that the users can select a potential contingency airfield and do a deep dive into key characteristics and criteria that relate to the field, and its suitability for the mission based on user-identified criteria. As shown, the suitability score of “76” is provided to the selected contingency landing site. Each contingency landing site is provided a suitability score based on selected criteria, as described herein. Further, the user interface depicts visual elements at the pixels identified by the artificial intelligence engine as representing the actual airway/runway of the contingency landing site and an overview of the associated field with key features may be highlighted for further review.

In the third block, at step “3.”, the diagram 1100 depicts that users can zoom into ground features, such as runway obstacles or hangars, and get highly accurate measurements and stand of distances to help plan operations and aircraft regeneration. Also, in the user interface depicted in the third block, feature images may be provided with measurements for multiple ground features that are identified in overlaid visual graphics, such as a table or chart.

In the fourth block, at step “4.”, the diagram 1100 depicts that the artificial intelligence engine may use multiple two-dimensional (2D) overhead images to generate 3D models of ground features and include them in an interactive, immersive 3D environments that users (e.g., using virtual avatar in some embodiments) can explore at the ground level for planning purposes. In addition, the user interface depicts an AI-generated 3D image of the hangar that allows for remote, “in person”site planning visits to remote locations.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

What is claimed is:

1. A computer-implemented method comprising:
receiving a search query as input, wherein the search query comprises certain criteria;
based on the search query, receiving data related to a geography of a certain area, wherein the data comprises one or more images of the certain area;
generating, based on the data and using an artificial intelligence engine, one or more contingency landing sites in the certain area, wherein each of the one or more contingency landing sites comprise at least a suitability score determined based on the certain criteria, and wherein the artificial intelligence engine is trained via tailored weights to identify each pixel associated with each of the one or more contingency landing sites in the images and to use one or more visual elements at each pixel to represent each of the one or more contingency landing sites in a visual model;
causing, on a user interface of a computing device, presentation of the visual model including the one or more visual elements at each pixel representing each of the one or more contingency landing sites; and
receiving a selection of a contingency landing site from the one or more contingency landing sites.

2. The computer-implemented method of claim 1, wherein the certain criteria comprise at least one of an airfield length, an airfield width, a geographic location, a desired facility, a type of aircraft, a length of the aircraft, a width of the aircraft, or some combination thereof.

3. The computer-implemented method of claim 1, further comprising:
generating, using the artificial intelligence engine, a three-dimensional (3D) model representing the selected contingency landing site, wherein the 3D model comprises geographical features including obstacles, objects, terrain, weather conditions, or some combination thereof; and
causing, on the user interface of the computing device, presentation the 3D model to enable a navigational survey.

4. The computer-implemented method of claim 1, wherein the artificial intelligence engine comprises one or more computer-implemented models that are trained with training data comprising inputs including at least a corpus of satellite images, geographic features, obstacles, objects, elements, weather conditions, aircraft types, maintenance capabilities, munition availability, fuel availability, runway lengths, runway widths, aircraft lengths, aircraft widths, or some combination thereof, and outputs including at least the one or more contingency landing sites, one or more suitability scores, one or more confidence scores, or some combination thereof.

5. The computer-implemented method of claim 1, further comprising
based on the suitability score of each of the one or more contingency landing site, ranking the one or more contingency landing site into a ranked list;
causing, on the user interface of the computing device, presentation of the ranked list of the one or more contingency landing sites, wherein a first contingency landing site having a highest rank is presented more prominently in the ranked list than a second contingency landing site having a lower rank.

6. The computer-implemented method of claim 1, wherein the one or more computer-implemented models are configured with one or more weights received from a server, and wherein the server generates the one or more weights via training the one or more computer-implemented models remotely from the computing device.

7. The computer-implemented model of claim 1, further comprising:
based on the selected contingency landing site, controlling operation of an aircraft, in real-time or near real-time, to navigate from a current location of the aircraft to the contingency landing site and to land at the contingency landing site.

8. The computer-implemented method of claim 1, further comprising:
generating, using the images, a three-dimensional (3D) model of the selected contingency landing site, wherein the 3D model comprises visual elements representing obstacles, power lines, terrain, objects, weather conditions, or some combination thereof.

9. The computer-implemented method of claim 8, further comprising:
causing presentation of the 3D model on a computing device of an air ambulance representative, wherein the air ambulance representative is enabled to provide, in real-time or near real-time, instructions to a pilot of the air ambulance on landing instructions at an identified location in the 3D model.

10. The computer-implemented method of claim 1, wherein the artificial intelligence engine comprises one or more computer-implemented models trained to perform segmentation of a plurality of wavelengths included in the images to identify pixels representing the one or more contingency landing sites.

11. The computer-implemented method of claim 1, wherein the artificial intelligence engine comprises one or more computer-implemented models trained with training data comprising a length of an airway, a width of an airway, a type of an aircraft, or some combination thereof.

12. One or more tangible, non-transitory computer-readable media storing instructions that, when executed, cause one or more processing devices to:
receive a search query as input, wherein the search query comprises certain criteria;
based on the search query, receive data related to a geography of a certain area, wherein the data comprises one or more images of the certain area;
generate, based on the data and using an artificial intelligence engine, one or more contingency landing sites in the certain area, wherein each of the one or more contingency landing sites comprise at least a suitability score determined based on the certain criteria, and wherein the artificial intelligence engine is trained via tailored weights to identify each pixel associated with each of the one or more contingency landing sites in the images and to use one or more visual elements at each pixel to represent each of the one or more contingency landing sites in a visual model;
cause, on a user interface of a computing device, presentation of the visual model including the one or more visual elements at each pixel representing each of the one or more contingency landing sites; and
receive a selection of a contingency landing site from the one or more contingency landing sites.

13. The computer-readable media of claim 12, wherein the certain criteria comprise at least one of an airfield length, an airfield width, a geographic location, a desired facility, a type of aircraft, a length of the aircraft, a width of the aircraft, or some combination thereof.

14. The computer-readable media of claim 12, wherein the one or more processing devices are further to:
generate, using the artificial intelligence engine, a three-dimensional (3D) model representing the selected contingency landing site, wherein the 3D model comprises geographical features including obstacles, objects, terrain, weather conditions, or some combination thereof; and
cause, on the user interface of the computing device, presentation the 3D model to enable a navigational survey.

15. The computer-readable media of claim 12, wherein the artificial intelligence engine comprises one or more computer-implemented models that are trained with training data comprising inputs including at least a corpus of satellite images, geographic features, obstacles, objects, elements, weather conditions, aircraft types, maintenance capabilities, munition availability, fuel availability, runway lengths, runway widths, aircraft lengths, aircraft widths, or some combination thereof, and outputs including at least the one or more contingency landing sites, one or more suitability scores, one or more confidence scores, or some combination thereof.

16. The computer-readable media of claim 12, wherein the one or more processing devices are further to:
based on the suitability score of each of the one or more contingency landing site, rank the one or more contingency landing site into a ranked list;
cause, on the user interface of the computing device, presentation of the ranked list of the one or more contingency landing sites, wherein a first contingency landing site having a highest rank is presented more prominently in the ranked list than a second contingency landing site having a lower rank.

17. The computer-readable media of claim 12, wherein the one or more computer-implemented models are configured with one or more weights received from a server, and wherein the server generates the one or more weights via training the one or more computer-implemented models remotely from the computing device.

18. The computer-readable media of claim 12, wherein the one or more processing devices are further to:
based on the selected contingency landing site, control operation of an aircraft, in real-time or near real-time, to navigate from a current location of the aircraft to the contingency landing site and to land at the contingency landing site.

19. The computer-readable media of claim 12, wherein the one or more processing devices are further to:
generate, using the images, a three-dimensional (3D) model of the selected contingency landing site, wherein the 3D model comprises visual elements representing obstacles, power lines, terrain, objects, weather conditions, or some combination thereof.

20. A system comprising:
one or more memory devices storing instructions; and
one or more processing devices communicatively coupled to the one or more memory devices, wherein the one or more processing devices execute the instructions to:
receive a search query as input, wherein the search query comprises certain criteria;
based on the search query, receive data related to a geography of a certain area, wherein the data comprises one or more images of the certain area;
generate, based on the data and using an artificial intelligence engine, one or more contingency landing sites in the certain area, wherein each of the one or more contingency landing sites comprise at least a suitability score determined based on the certain criteria, and wherein the artificial intelligence engine is trained via tailored weights to identify each pixel associated with each of the one or more contingency landing sites in the images and to use one or more visual elements at each pixel to represent each of the one or more contingency landing sites in a visual model;
cause, on a user interface of a computing device, presentation of the visual model including the one or more visual elements at each pixel representing each of the one or more contingency landing sites; and
receive a selection of a contingency landing site from the one or more contingency landing sites.
